(19) United States
(12) Patent Application Publication
(10) Pub. No.: US 2012/0319617 A1
(43) Pub. Date: Dec. 20, 2012

(54) LED Lighting Device

(76) Inventor: Chih-Chien Yen, New Taipei City (TW)

(21) Appl. No.: 13/161,244

(22) Filed: Jun. 15, 2011

(51) Int. Cl. H05B 37/02

(52) U.S. Cl. 315/294

(57) ABSTRACT

The present invention provides a LED lighting device comprises a light source unit, a control unit and an analog to digital converter. The light source unit has at least a red LED, a green LED, a blue LED and an ultraviolet LED. The control unit causes the light source unit to emit mixing color light. the control unit has at least four current drivers connected the red LED, the green LED, the blue LED and the ultraviolet LED. The analog to digital convert connects to the control unit for converting an alternate-current (AC) power into a direct-current (DC) power, wherein the DC power are distributed to the control unit.

### BACKGROUND

1. Field of Invention

The present invention relates to a LED (light emitting diode) device, and more particularly to a LED device with improved color rendering ability.

2. Description of Related Art

Light emitting diodes (LEDs) are attractive candidates for replacing conventional light sources such as incandescent lamps and fluorescent light sources. The LEDs have higher light conversion efficiencies and longer lifetimes than incandescent lamps. In addition, the LEDs require lower operating voltages and are more economical than fluorescent light sources.

To produce a light source is perceived to have an arbitrary color, a compound light source having multiple LEDs is typically utilized. All colors are formed of different combinations of red, green, and blue (RGB) components. Controlling the relative intensity ratio of the different contributions of red, green, and blue components allows multiple colors to be displayed. Currently, most of the LED-based color lamps available in the market provide various colored light by individually turning on and off the red, green, and blue LEDs of the lamp. For example, a control circuit of the lamp provides a 3-bit digital signal with each bit controlling whether to turn on (1) or off (0) the red, green, and blue LEDs, respectively. The lamp is therefore able to generate light of seven different colors, including red (001), green (010), blue (100), red plus green (011), green plus blue (110), blue plus red (101), and red plus green plus blue (111). In order to generate light of more different colors, the brightness of the individual red, green, blue LEDs has to be adjustable, instead of having only “on” and “off” two choices, so as to produce more color combinations.

However, an LED produces light in a relatively narrow spectral band. Some colors in the nature can not be generated by combining the red, green, and blue (RGB) components. That is, a color of an object lighted by the sun is different from that of this object lighted by a LED device. The color rendering ability of a LED light source to reproduce the colors of various objects faithfully in comparison with an ideal or natural light source has to be improved. It would therefore be desirable to develop new LED based solutions with a full spectrum.

### SUMMARY

An object of the present invention is to provide a LED lighting device with an improved color rendering ability.

The present invention provides a LED lighting device comprises a light source unit, a control unit and an analog to digital converter. The light source unit has at least a red LED, a green LED, a blue LED and an ultraviolet LED. The control unit causes the light source unit to emit mixing color light. the control unit has at least four current drivers connected the red LED, the green LED, the blue LED and the ultraviolet LED. The analog to digital convert connects to the control unit for converting an alternate-current (AC) power into a direct-current (DC) power, wherein the DC power are distributed to the control unit.

In an embodiment, the DC power further comprises at least four DC voltages supplied to the four current drivers.

In an embodiment, the LED lighting device further comprises a controller to vary the four DC voltages supplied to the four current drivers, and the four current drivers deliver corresponding amounts of current to the red LED, the green LED, the blue LED and the ultraviolet LED.

In an embodiment, the light source unit has at least an additional LED of a color other than red, green, and blue.

The present invention further provides a LED lighting device comprises a light source unit, a control unit and an analog to digital converter. The light source unit has at least a color LED and an ultraviolet LED. The control unit provides current to drive the color LED and the ultraviolet LED. The analog to digital convert connected to the control unit for converting an alternate-current (AC) power into a direct-current (DC) power, wherein the DC power are supplied to the control unit.

Accordingly, the color mixing LED device of the present invention additionally utilizes an ultraviolet (UV) LED to incorporate with the red, green, and blue (RGB) LEDs to generate a light. Therefore, the color mixing LED device has an improved color rendering capability.

### BRIEF DESCRIPTION OF THE DRAWINGS

In order to make the foregoing as well as other aspects, features, advantages, and embodiments of the present invention more apparent, the accompanying drawings are described as follows:

FIG. 1 illustrates an overall view of a color mixing LED device 100 of the present invention is shown.

### DETAILED DESCRIPTION

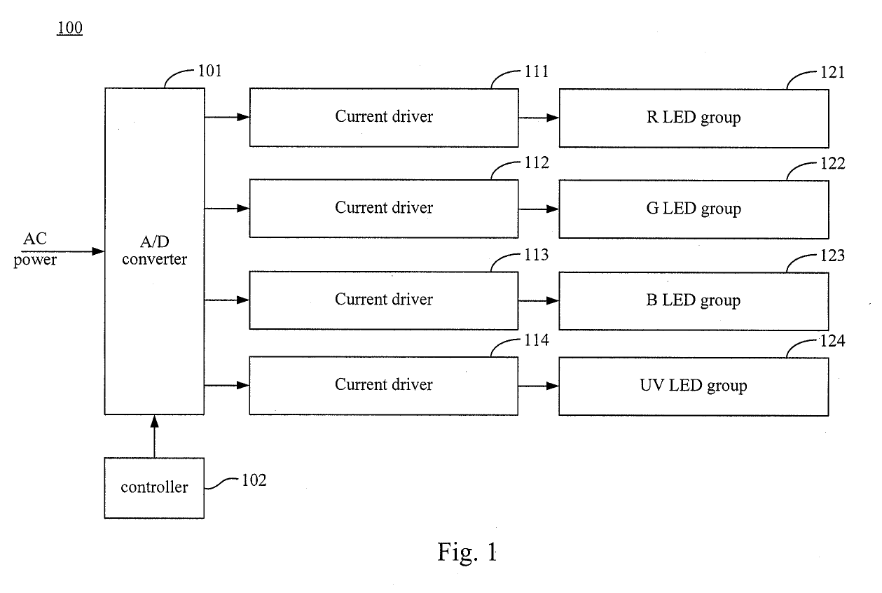

Reference will now be made in detail to the present embodiments of the invention, examples of which are illustrated in the accompanying drawings. Wherever possible, the same reference numbers are used in the drawings and the description to refer to the same or like parts. The present inventor recognized that currently devices utilizing light emitting diodes (LEDs) are not widely utilized in lighting because of a color rendering problem. Therefore, the present invention utilizes an ultraviolet (UV) LED to incorporate with the red, green, and blue (RGB) LEDs to generate a light similar to the light of the sun. FIG. 1 thereof, an overall view of a color mixing LED device 100 of the present invention is shown.

As shown in FIG. 1, the color mixing LED device 100 includes an Analog to Digital (ND) converter 101, four groups of electric current drivers 111, 112, 113 and 114, and three groups of color LEDs 121, 122, 123 and an ultraviolet LED 124. Each current driver 111, 112, 113 and 114 is provided for a respective of three different color LEDs, which in this embodiment include a red LED group 121, a green LED group 122, and a blue LED group 123, and an ultraviolet LED 124. LEDs of each color 121, 122 and 123 and ultraviolet light 124 are connected in series, each of which is driven by an individual electric current driver 111, 112, 113 and 114. The present invention is directed to a device that can mix colors output from different color LEDs. Depending on specific requirements, other combinations of colors and numbers of LEDs can be adopted in alternative embodiments. For example, in addition to the red, green, and blue LEDs, there can be at least an additional LED of a color other than red, green, and blue to combine with the ultraviolet LED 124 to generate a light color that more reach the nature light.

The analog to Digital (A/D) converter 101 receives an alternate-current (AC) power from a power supply (not shown in the figure) and converts the alternate-current (AC) power into the direct-current (DC) power required by the current driver 111, 112, 113 and 114. The DC power output from the analog to Digital (ND) converter 101 is fed to the current driver 111, 112, 113 and 114. The output of the current driver 111, 112, 113 and 114 is connected to the red LED group 121, the green LED group 122, the blue LED group 123, and the ultraviolet LED 124, respectively. As described above, the current driver 111, 112, 113 and 114 receive the output voltages from the analog to Digital (A/D) converter 101, and, based on the voltages applied to them, the current driver 111, 112, 113 and 114 produce an appropriate amount of current to flow through the red LED group 121, the green LED group 122, the blue LED group 123, and the ultraviolet LED 124, respectively. The DC power from the analog to Digital (A/D) converter 101 is regulated to the desired voltage level and distributed to the four current drivers 111, 112, 113 and 114. That is, a controller 102 can control the analog to Digital (A/D) converter 101 to output different voltage levels to the current driver 111, 112, 113 and 114 respectively. For example, the control 102 is implemented by variable resistors or any similar means to adjust the voltages output to the current driver 111, 112, 113 and 114 respectively. Therefore, by the controller 102, the output voltage of analog to Digital (A/D) converter 101 on the four corresponding current driver 111, 112, 113 and 114 can be varied.

According to the Ohm's law, the current flowing through each LED can be determined by the internal resistance of the LEDs and the forward bias voltage of the LED. Therefore, As forward bias voltage and internal resistance are constant, when the voltage output from the analog to Digital (A/D) converter 101 varies, the current supplied from the current driver 111, 112, 113 and 114 varies accordingly.

To obtain a desired colored light, the brightness of the red LED group 121, the green LED group 122, the blue LED group 123, and the ultraviolet LED 124 are adjusted by the controller 102 varying the output voltages of the analog to Digital (A/D) converter 101. Thereby, the output voltages of the current driver 111, 112, 113 and 114 are adjusted to vary the current flowing through the red LED group 121, the green LED group 122, the blue LED group 123. Consequently, the brightness of each of the red LED group 121, the green LED group 122, the blue LED group 123, and the ultraviolet LED 124 is adjusted to the desired level. The human eyes can thus perceive different colors from mixing the red, green and blue colored light and the ultraviolet light of different brightness. As the brightness for each of red, green, blue LEDs and ultraviolet LEDs can be individually and linearly adjusted from complete darkness to full brightness, any colored light in the visible light spectrum can be produced by the color mixing LED device 100.

Accordingly, the color mixing LED device of the present invention additionally utilizes an ultraviolet (UV) LED to incorporate with the red, green, and blue (RGB) LEDs to generate a light. Therefore, the color mixing LED device has an improved color rendering capability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A LED lighting device, comprising:
a light source unit having at least a red LED, a green LED, a blue LED and an ultraviolet LED;
a control unit causing said light source unit to emit mixing color light, having at least four current drivers connected the red LED, the green LED, the blue LED and the ultraviolet LED; and
an analog to digital convert connected to the control unit for converting an alternate-current (AC) power into a direct-current (DC) power, wherein the DC power are distributed to the control unit.

2. The LED lighting device of claim 1, wherein the DC power further comprising at least four DC voltages supplied to the four current drivers.

3. The LED lighting device of claim 2, wherein further comprises a controller to vary the four DC voltages supplied to the four current drivers, and the four current drivers deliver corresponding amounts of current to the red LED, the green LED, the blue LED and the ultraviolet LED.

4. The LED lighting device of claim 1, wherein the light source unit has at least an additional LED of a color other than red, green, and blue.

5. A LED lighting device, comprising:
a light source unit having at least a color LED and an ultraviolet LED;
a control unit providing current to drive the color LED and the ultraviolet LED; and
an analog to digital convert connected to the control unit for converting an alternate-current (AC) power into a direct-current (DC) power, wherein the DC power are supplied to the control unit.

6. The LED lighting device of claim 5, wherein the color LED further comprises a red LED, a green LED, and a blue LED.

7. The LED lighting device of claim 6, wherein the control unit has at least four current drivers connected the red LED, the green LED, the blue LED and the ultraviolet LED, and the DC power comprises four DC voltages supplied to the four current drivers.

8. The LED lighting device of claim 7, wherein further comprises a controller to vary the four DC voltages supplied to the four current drivers, and the four current drivers deliver corresponding amounts of current to the red LED, the green LED, the blue LED and the ultraviolet LED.
